(19) United States
(12) Patent Application Publication
(10) Pub. No.: US 2006/0159433 A1
(43) Pub. Date: Jul. 20, 2006

(54) Composite video apparatus for storing system program in hard disc drive (HDD)

(75) Inventor: Hee Yong Cho, Yongin-Si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/283,735

(22) Filed: Nov. 22, 2005

(30) Foreign Application Priority Data
Jan. 20, 2005 (KR) 10-2005-0005478

(51) Int. Cl. H04N 5/85

(52) U.S. Cl. 386/126

(57) ABSTRACT

A composite video apparatus that is configured to store a system program in a Hard Disc Drive (HDD) instead of a ROM. The composite video apparatus includes a Digital Video Disc (DVD) drive for recording audio and video (AV) data to a DVD or reading the AV data recorded in the DVD, an HDD for storing a system program and recording the AV data independently of the DVD drive, and a microprocessor for controlling the DVD drive and the HDD.

### CROSS-REFERENCE TO RELATED APPLICATIONS

This application claims the benefit under 35 U.S.C. §119(a) of Korean Patent Application No. 10-2005-0005478, filed in the Korean Intellectual Property Office on Jan. 20, 2005, the entire disclosure of which is incorporated herein by reference.

### BACKGROUND OF THE INVENTION

1. Field of the Invention

The present invention relates to a composite video apparatus for storing a system program in a Hard Disc Drive (HDD). More particularly, the present invention relates to a composite video apparatus for storing a system program (that is, firmware) of an HDD in the HDD, and using the stored system program as needed.

2. Description of the Related Art

Generally, a conventional composite video apparatus includes at least two video devices therein, and combines the two video devices with each other, resulting in a single integrated system. There are a variety of such composite video apparatuses, for example, a DVD/VCR combo in which a DVDP (DVD Player) and a VCR (Video Cassette Recorder) are combined with each other, an HDD/DVD recorder in which an HDD and a DVD are combined with each other, and so forth.

An example of the above-described conventional HDD/DVD recorder is disclosed in Korean Patent Laid-open Publication No. 2003-0067248, the entire disclosure of which is incorporated herein by reference, and comprises an A/V encoder module for encoding input audio and video data according to MPEG formats, an A/V decoder module for decoding the encoded input audio and video data according to the MPEG formats, a loader engine including an HDD and a DVD drive, a flash ROM for storing firmware therein, and a microprocessor for controlling a RAM and the above components.

When the above-described HDD/DVD recorder is powered on, the firmware stored in the flash ROM is decompressed in the RAM such that the HDD/DVD recorder is booted. When the HDD/DVD recorder is booted, it stores external input image data in an HDD or a DVD (for example, a DVD-R, -RW, -RAM, or the like) or reproduces the stored image data upon receiving a request from a user. If needed, the HDD/DVD recorder copies image data stored in the HDD to a DVD, or copies image data stored in the DVD to the HDD.

However, the above-described conventional HDD/DVD recorder requires a costly flash ROM for storing firmware, even though it includes an HDD functioning as a high-capacity storage unit, thereby resulting in increased production costs.

Accordingly, a need exists for a system and method for storing a system program in a Hard Disc Drive (HDD) instead of a ROM in a composite video apparatus.

### SUMMARY OF THE INVENTION

Therefore, it is an aspect of the present invention to substantially solve the above and other problems, and provide a composite video apparatus for storing a system program in a Hard Disc Drive (HDD) instead of a ROM.

Additional aspects and advantages of the present invention will be set forth in part in the description which follows and, in part, will be obvious from the description.

In accordance with an exemplary embodiment of the present invention, the above and other aspects can be achieved by providing a composite video apparatus for storing a system program in a Hard Disc Drive (HDD), wherein the apparatus comprises a Digital Video Disc (DVD) drive for recording audio and video (AV) data to a DVD or for reading AV data recorded in the DVD, an HDD for storing a system program and recording the AV data independently of the DVD drive, and a microprocessor for controlling the DVD drive and the HDD.

### BRIEF DESCRIPTION OF THE DRAWINGS

These and other aspects and advantages of the present invention will become apparent and more readily appreciated from the following description of the embodiments, taken in conjunction with the accompanying drawings, of which:

FIG. 1 is a block diagram illustrating a composite video apparatus according to an embodiment of the present invention; and

FIG. 2 is a detailed block diagram illustrating an HDD for storing a system program as shown in the composite video apparatus of FIG. 1 according to an embodiment of the present invention.

Throughout the drawings, like reference numerals will be understood to refer to like parts, components and structures.

### DETAILED DESCRIPTION OF THE EXEMPLARY EMBODIMENTS

Reference will now be made in detail to embodiments of the present invention, examples of which are illustrated in the accompanying drawings, wherein like reference numerals refer to like elements throughout. Embodiments of the present invention are described below to explain the present invention by referring to the figures.

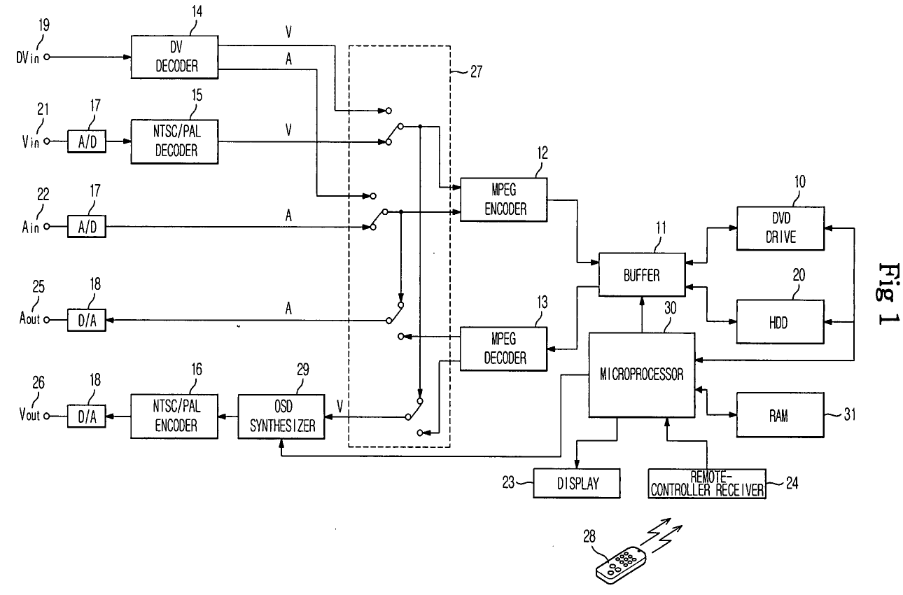

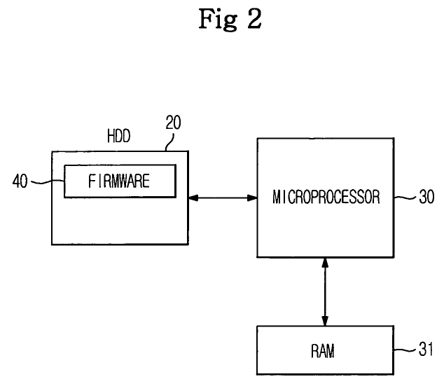

As shown in FIGS. 1 and 2, an HDD/DVD recorder according to an embodiment of the present invention comprises a plurality of input terminals 19, 21, and 22, a plurality of output terminals 25 and 26, a plurality of A/D converters 17, a plurality of D/A converters 18, a DV decoder 14, an NTSC/PAL decoder 15, and an NTSC/PAL encoder 16. The HDD/DVD recorder further comprises a switching circuit 27, an MPEG encoder 12, an MPEG decoder 13, a microprocessor 30, an OSD (On Screen Display) synthesizer 29, a buffer 11, a DVD drive 10, an HDD 20, a display 23, a remote-controller receiver 24, and a RAM 31.

The plurality of input terminals comprise a digital interface terminal (DVin) 19, a video input terminal (Vin) 21, and an audio input terminal (Ain) 22. Data, specifically AV data in the form of a Digital Video (DV) format, is applied to the digital interface terminal 19. A video signal in the form of an NTSC or PAL format is applied to the video input terminal 21. An audio signal is applied to the audio input terminal 22.

The plurality of output terminals comprise a video output terminal (Vout) 26 and an audio output terminal (Aout) 25. The video output terminal 26 is connected to a TV (not shown), and outputs a video signal in the form of an NTSC or PAL format to the TV. The audio output terminal 25 is connected to an audio device (not shown), and outputs an audio signal to the audio device.

The DV decoder 14 receives AV data in the form of a digital video format via the digital interface terminal (DVin) 19, and converts the AV data into video and audio signals in the form of an ITU (International Telecommunication Union)—R BT format. The NTSC/PAL decoder 15 converts the NTSC or PAL—format video signal applied to the video input terminal 21 into an ITU-R BT—format video signal. The NTSC/PAL encoder 16 converts the ITU-R BT—format video signal received from the MPEG decoder 13 into an NTSC or PAL—format video signal.

When recording the AV data of a digital video (DV) format, the switching circuit 27 transmits the video signal generated from the NTSC/PAL decoder 15 to the MPEG encoder 12 and the OSD synthesizer 29, and transmits an audio signal generated from the DV decoder 14 to the MPEG encoder 12 and the audio output terminal (Aout) 25. When reproducing the AV data of a DV format, the switching circuit 27 transmits a video signal generated from the MPEG decoder 13 to the OSD synthesizer 29, and transmits an audio signal generated from the MPEG decoder 13 to the audio output terminal (Aout) 25.

The MPEG encoder 12 compresses and encodes the video signal of an ITU-R BT format and a digitalized audio signal using an MPEG-2 scheme, such that it generates an AV data stream. The MPEG decoder 13 converts the AV data stream into the video signal of an ITU-R BT format.

The microprocessor 30 stores a minimum number of requisite programs required for booting a system. Typically, the requisite programs perform operations similar to those of a ROM BIOS used for booting a computer. In addition, the microprocessor 30 controls the individual components comprised by the HDD/DVD recorder, forms an OSD image to be displayed on a TV connected to the HDD/DVD recorder, and transmits the OSD image to the OSD synthesizer 29. The OSD synthesizer 29 can then display the OSD image received from the microprocessor 30 on the TV. The buffer 11 can be used to temporarily store the AV data stream. The DVD drive 10 can seat a DVD therein, and record data to the DVD or read the data from the DVD.

The HDD 20 comprises a storage capacity of several Gigabytes or several tens of Gigabytes, and stores a system program (that is, firmware) as shown in greater detail in FIG. 2. The firmware 40 is indicative of an aggregation of micro-programs that are capable of controlling hardware. The exemplary embodiment of the present invention shown in FIGS. 1 and 2 stores the firmware 40 in a specific area of the HDD 20, whereas a conventional HDD/DVD recorder stores the firmware in a flash ROM.

The remote-controller receiver 24 receives a signal from the remote-controller 28, and transmits the received signal to the microprocessor 30. The remote-controller 28 can comprise a plurality of operator buttons, such as a power-supply button for powering on the HDD/DVD recorder.

Operations of the HDD/DVD recorder shown in FIGS. 1 and 2 will now be described in greater detail. In accordance with an exemplary embodiment of the present invention, when the HDD/DVD recorder is manufactured, the firmware 40 is stored in a specific area of the HDD 20 instead of a flash ROM. In this case, the flash ROM is no longer required, such that there is no need for the HDD/DVD recorder to additionally include a flash ROM for storing the firmware 40.

When a user pushes a power-supply button of the remote-controller 28 to power on the above-described HDD/DVD recorder, the remote-controller receiver 24 transmits the user request for powering on the HDD/DVD recorder to the microprocessor 30. Upon receipt of the user request from the remote-controller receiver 24, the microprocessor 30 accesses the HDD 20 using stored requisite programs. The microprocessor 30 performs the loading of the firmware 40 stored in the specific area of the HDD 20, and decompresses the loaded firmware 40 in the RAM 31, such that it boots the HDD/DVD recorder.

After booting the HDD/DVD recorder, the microprocessor 30 can receive any number of request signals from the user, such that it stores data received via the input terminals in the HDD 20 or the DVD, or performs other operations.

As is apparent from the above description, a composite video apparatus according to an embodiment of the present invention stores a system program in an HDD differently from the conventional devices, such that embodiments of the present invention do not require an additional flash ROM for storing a system program, resulting in reduced production costs.

Although a few embodiments of the present invention have been shown and described, it can be appreciated by those skilled in the art that changes may be made in these embodiments without departing from the principles and spirit of the invention, the scope of which is defined in the following claims and their equivalents.

What is claimed is:

1. A composite video apparatus for storing a system program in a Hard Disc Drive (HDD), comprising:
a Digital Video Disc (DVD) drive for recording audio and video (AV) data to a DVD or reading AV data recorded in the DVD;
an HDD for storing a system program and recording the AV data independently of the DVD drive; and
a microprocessor for controlling the DVD drive and the HDD.

2. The apparatus according to claim 1, further comprising:
a RAM, wherein the microprocessor controls the system program stored in the HDD to be decompressed in the RAM.

3. The apparatus according to claim 1, wherein the system program is stored in the HDD when the composite video apparatus is manufactured.

4. A composite video apparatus for storing a system program in a Hard Disc Drive (HDD), comprising:
a Digital Video Disc (DVD) drive for recording audio and video (AV) data to a DVD or reading AV data recorded in the DVD;
an HDD for recording the AV data independently of the DVD drive; and
a microprocessor for controlling the DVD drive and the HDD, wherein the HDD stores a system program instead of a ROM.

5. A method for storing a system program in a Hard Disc Drive (HDD) of a composite video apparatus, comprising the steps of:
recording audio and video (AV) data to a DVD or reading AV data recorded in a Digital Video Disc (DVD) drive;
storing a system program and recording the AV data independently of the DVD drive in an HDD; and
controlling the DVD drive and the HDD using a microprocessor.

6. The method according to claim 5, further comprising the step of:
controlling the system program stored in the HDD to be decompressed in a RAM.
